(19) United States
(12) Patent Application Publication
(10) Pub. No.: US 2007/0126585 A1
(43) Pub. Date: Jun. 7, 2007

(54) System integration of RFID and MIMO technologies

(75) Inventors: Yuri Okunev, Middle Island, NY (US); Kevin J. Powell, Annapolis, MD (US); Michael Arneson, Finksburg, MD (US); William R. Bandy, Gambrills, MD (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 11/294,464

(22) Filed: Dec. 6, 2005

(51) Int. Cl. G08B 13/14; H04Q 5/22

(52) U.S. Cl. 340/572.7; 340/10.1; 340/572.2

(57) ABSTRACT

An embodiment of the present invention provides a system including a plurality of radio frequency identification (RFID) tags and a reader. Each RFID tag of the plurality of RFID tags backscatter transmits a signal. In one embodiment, the reader includes a plurality of antennas and a signal processor. In another embodiment, the system includes a signal processor and a plurality of readers each including an antenna. In either embodiment, each antenna receives a plurality of signals corresponding to the backscatter transmitted signals. The signal processor combines the received plurality of signals to produce an output signal.

### BACKGROUND OF THE INVENTION

1. Field of the Invention

The present invention relates to radio frequency identification (RFID) systems and methods for transmitting signals between RFID tags and readers.

2. Background Art

Radio frequency identification (RFID) tags are electronic devices that may be affixed to items whose presence is to be detected and/or monitored. The presence of an RFID tag, and therefore the presence of the item to which the tag is affixed, may be checked and monitored by devices known as “readers.” Readers typically transmit radio frequency signals to which the RFID tags respond. Each RFID tag can store a unique identification number or other identifiable information. The RFID tags respond to the reader by inserting into the backscatter signal their identification numbers or other identifiable information, so that the tags can be identified.

Information transmitted between an RFID tag and a reader is limited by data rate and operational range. In telecommunications and electronics, the data rate refers to the aggregate rate at which data pass a point in the transmission path of a data transmission system. Operational range refers to the maximum separation between a transmitter and a receiver over which signals can reliably be transmitted and received. New high-speed RFID systems require information to be transmitted at higher data rates and longer ranges than are currently available.

Given the foregoing, what is needed is a more efficient method and architecture for transmitting signals between an RFID tag and a reader. Such a method and architecture should enable desired performance with minimum signal power requirements and maximum range of operation.

### BRIEF SUMMARY OF THE INVENTION

Embodiments of the present invention provide a system and method for transmitting and receiving signals between an RFID tag and a reader by integrating RFID technology with Multiple-Input-Multiple-Output (MIMO) technology. The integration of these technologies can provide dramatically increased data rates and ranges of operation. These improvements can be achieved while maintaining currently accepted (or even less) signal power and channel bandwidth use.

An embodiment of the present invention provides a system including a plurality of RFID tags and a reader. Each RFID tag backscatter transmits a signal. The reader includes a plurality of antennas and a signal processor. Each antenna of the plurality of antennas receives a plurality of signals corresponding to the backscatter transmitted signals. The signal processor combines the received plurality of signals to produce an output signal. By using a plurality of RFID tags to transmit the backscatter signals, an RFID/MIMO system in accordance with this embodiment can achieve a relatively long operation range.

Another embodiment of the present invention provides a system including a plurality of RFID tags, a plurality of readers and a signal processor. Each RFID tag backscatter transmits a signal. Each reader of the plurality of readers includes an antenna. Each antenna of the plurality of antennas receives a plurality of signals corresponding to the backscatter transmitted signals. The signal processor combines the received plurality of signals to produce an output signal. By using a plurality of readers, an RFID/MIMO system in accordance with this embodiment can achieve a relatively low signal power.

A further embodiment of the present invention provides a method including the following steps. A plurality of RFID tag signals are backscatter transmitted. A plurality of signals corresponding to the backscatter transmitted plurality of RFID tag signals are received by a plurality of antennas, wherein each antenna in the plurality of antennas receives the plurality of signals corresponding to the backscatter transmitted plurality of RFID tag signals. The received plurality of partial signals are combined to produce an output signal.

These and other objects, advantages and features will become readily apparent in view of the following detailed description of the invention. Note that the Summary and Abstract sections may set forth one or more, but not all exemplary embodiments of the present invention as contemplated by the inventors.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art(s) to make and use the invention.

FIG. 1 illustrates an environment where RFID readers communicate with an exemplary population of RFID tags in accordance with an embodiment of the present invention.

FIG. 2 illustrates a radio system with spatial diversity at a receiving site.

FIG. 3 illustrates a multiple-input-multiple-output (MIMO) radio system with spatial diversity at both a transmitting site and a receiving site.

FIG. 4A illustrates an architecture of a RFID/MIMO system with a single reader having a plurality of spatially diverse antennas in accordance with an embodiment of the present invention.

FIG. 4B illustrates a multi-antenna reader in accordance with an embodiment of the present invention.

FIG. 5 illustrates an architecture of a RFID/MIMO system with a plurality of spatially diverse readers each including an antenna in accordance with an embodiment of the present invention.

FIG. 6 illustrates a 2:2 RFID/MIMO system based on an Alamouti space-time block code (STBC) in accordance with an embodiment of the present invention.

FIG. 7 depicts a flowchart illustrating a method of transmitting and receiving RFID tag signals in accordance with an embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

Introduction

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

As described in more detail herein, an embodiment of the present invention integrates RFID and MIMO technologies to provide a system and method. Such an integrated RFID/MIMO system and/or method can provide dramatically increased data rates and operation ranges. Furthermore, such an integrated RFID/MIMO system can maintain accepted levels, or even lower levels, of signal power and channel bandwidth use. First, before describing embodiments of the present invention, an example RFID tag environment and an example MIMO environment are described. Second, various example architectures for integrating RFID and MIMO technologies are described. Third, example operations of an integrated RFID/MIMO system are described. Finally, an example method for implementing an RFID/MIMO system is described.

Overview of RFID Technology

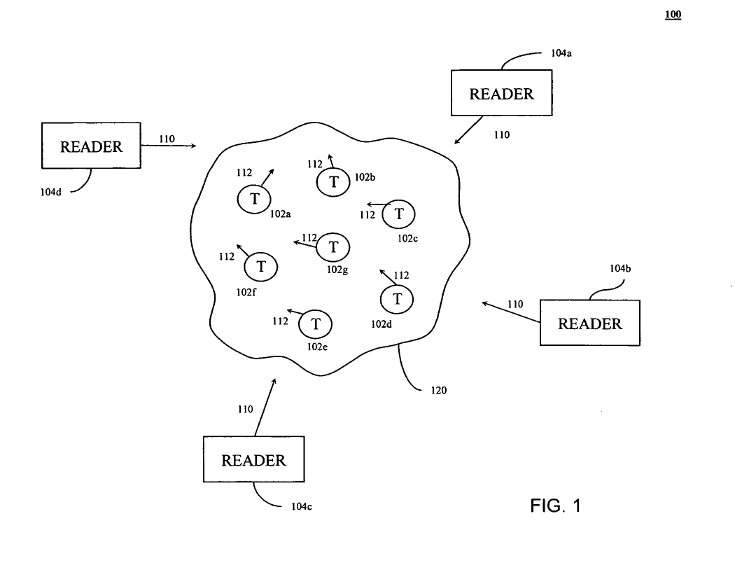

Before describing embodiments of the present invention in detail, it is helpful to describe an example environment in which embodiments of the present invention may be implemented. FIG. 1 illustrates an environment 100 where RFID tag readers 104 communicate with an exemplary population 120 of RFID tags 102. As shown in FIG. 1, the population 120 of tags includes seven tags 102a-102g. According to embodiments of the present invention, a population 120 may include any number of tags 102.

Environment 100 also includes readers 104a-104d. Readers 104 may operate independently or may be coupled together to form a reader network. A reader 104 may be requested by an external application to address the population of tags 120. Alternatively, reader 104 may have internal logic that initiates communication, or may have a trigger mechanism that an operator of reader 104 uses to initiate communication.

As shown in FIG. 1, a reader 104 transmits an interrogation signal 110 having a carrier frequency to the population of tags 120. The reader 104 operates in one or more of the frequency bands allotted for this type of RF communication. For example, frequency bands of 902-928 MHz and 2400-2483.5 MHz have been defined for certain RFID applications by the Federal Communication Commission (FCC). Furthermore, due to regulatory or operational considerations, reader 104 may change carrier frequency on a periodic basis (e.g., ranging from 50 to 400 milliseconds) within the operational band. In these “frequency hopping” systems, the operational band is divided into a plurality of channels. For example, the 902-928 MHz frequency band may be divided into 25 to 50 channels, depending upon the maximum bandwidth defined for each channel. The maximum allowable bandwidth for each channel may be set by local or national regulations. For example, according to FCC Part 15, the maximum allowed bandwidth of a channel in the 902-928 MHz band is 500 kHz. Each channel is approximately centered around a specific frequency, referred to herein as the hopping frequency.

In one embodiment, a frequency hopping reader changes frequencies between hopping frequencies according to a pseudorandom sequence. Each reader 104 typically uses its own pseudorandom sequence. Thus, at any one time, a first reader 104a may be using a different carrier frequency than another reader 104b.

Various types of tags 102 transmit one or more response signals 112 to an interrogating reader 104 in a variety of ways, including by alternatively reflecting and absorbing portions of signal 110 according to a time-based pattern or frequency. This technique for alternatively absorbing and reflecting signal 110 is referred to herein as backscatter modulation. Tags 102 can also use different types of encoding techniques (such as, FM0 and Miller encoding) and modulation techniques (such as, amplitude shift keying and phase shift keying modulation). However, other and more complex encoding and modulation methods (for example, Trellis encoding and quadrature amplitude modulation) may be utilized in embodiments of the present invention. Reader 104 receives response signals 112, and obtains data from response signals 112, such as an identification number of the responding tag 102.

As mentioned above, an embodiment of the present invention integrates RFID technology with MIMO technology. Before describing such an integrated embodiment, however, an overview of the MIMO technology is given.

Overview of Multiple-Input-Multiple-Output Technology

Multiple-Input-Multiple-Output (MIMO) technology is currently a promising approach to wireless system design. MIMO models have been standardized in the IEEE 802.16 for fixed broadband wireless access (“WiMAX”) and in the 3rd Generation Partnership Project (3GPP) for mobile applications. In fact, standardization of MIMO solutions for the 3rd generation wireless systems has begun in the International Telecommunication Union (ITU) and 3GPP standards committees.

MIMO technology has received attention from both the academic community and the telecommunications industry because it is a breakthrough in wireless technology. As the name suggests, a MIMO system includes a plurality of antennas at a transmitting site and a plurality of antennas at a receiving site. Theoretical estimations of the energy gain that is achievable in a MIMO system are impressive. For example, a MIMO system, having two transmitting and two receiving antennas, provides up to 12 dB energy gain for a channel with Rayleigh fading; whereas a typical radio system with sophisticated encoding techniques provides a 3 dB energy gain for a channel with Rayleigh fading. In addition, the channel capacity gain for a MIMO system is equally impressive. For a MIMO system the channel capacity is equal to the minimum of the number of antennas in the transmitting site and the number of antennas in the receiving site. As a result, a MIMO system with four transmitting antennas and four receiving antennas allows the system to increase the data rate by four times compared to a single antenna system. This increased data rate is achieved while maintaining the same signal power and bandwidth use as a single antenna system.

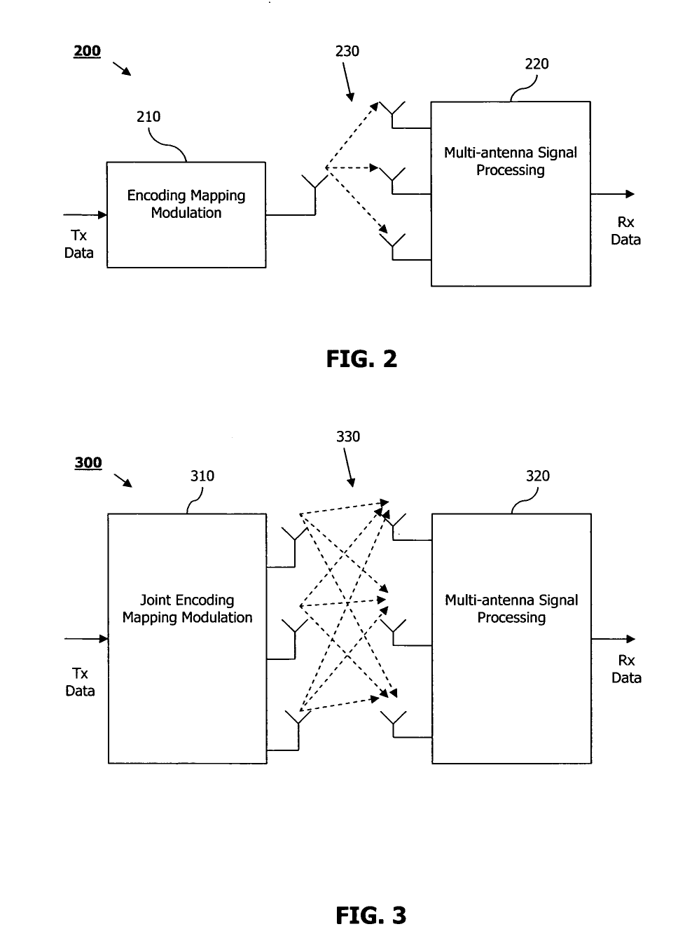

MIMO developed from a well-known space (spatial) diversity technique. Space diversity has been used in radio systems with multipath propagation for many decades. “Space diversity” or “spatial diversity” in a radio system refers to a plurality of antennas located in different (“space diverse”) locations. FIG. 2 illustrates a block-diagram of a typical radio system 200 with spatial diversity. As shown in FIG. 2, system 200 includes an encoding mapping modulation block 210 at a transmitting site and a multi-antenna signal processing block 220 at a receiving site.

Radio system 200 is referred to herein as a Spatial Diversity system or a 1:N_{R}-system, where the first digit (i.e., 1) refers to the number of antennas at the transmitting site and the second digit (i.e., “N_{R}”—a variable number) refers to the number of antennas at the receiving site. As shown in FIG. 2, there is one antenna at the transmitting site and three antennas (N_{R}=3) at the receiving site. The transmitting site of system 200 is similar to a typical transmitting site of a conventional radio system (1:1 system) or Single-Antenna system. At the transmitting site, encoding-mapping-modulation block 210 encodes and maps input data and provides proper modulation of the carrier. A modulated signal 230 is then emitted by an antenna of encoding-mapping-modulation block 210.

The receiving site of system 200 includes N_{R} spatially diverse antennas each having a corresponding high frequency (HF) front end. The receiving site also includes a multi-antenna signal processing block 220 that provides multi-antenna signal processing. Processing block 220 typically includes an algorithm for combining partial signals received by the spatially diverse antennas. The partial signals are (e.g., linearly) combined in order to provide the maximum likely estimation of the transmitted data. Optimal signal processing of the multi-antenna signal is based on a weighted coherent or non-coherent accumulation of spatially diverse antenna signals. For example, a rake demodulator is a typical receiver that provides coherent accumulation of multi-path signal components.

In radio system 200 with spatial diversity (1:N_{R}-system), the number of signal replicas at the receiving site is equal to the number of diverse antennas N_{R}. As is well-known, the Shannon Theorem indicates that the channel capacity increases by the logarithm of the signal-to-noise ratio. Accordingly, increasing the number of antennas at the receiving site in radio system 200 only results in a logarithmic increase in channel capacity. For example, assuming ideal conditions (i.e., uncorrelated fading, optimal coherent accumulation, and a perfect estimation of signal-to-noise ratios (SNRs) in the antennas), the channel capacity of a Spatial Diversity system (similar to radio system 200) having four antennas at the receiving site is two times greater than the channel capacity of a Single-Antenna system. Mathematically, this can be represented as
C_{(1:N}_{_{R}}₎˜log₂(N_{R})C_{(1:1)}˜log₂(4)C_{(1:1)}˜2C_{(1:1)}, (1)
where C_{(1:N}_{_{R}}₎ is the channel capacity of the Spatial Diversity system with one transmitting antenna and N_{R} receiving antennas (which in this example is four), and C_{(1:1)} is the channel capacity of a Single Antenna system.

In contrast to radio system 200 with spatial diversity only in the receiving site, a MIMO system has spatial diversity in both a transmitting site and a receiving site. Consequently, a MIMO system is commonly referred to as a N_{T}:N_{R}-system, wherein N_{T} represents the number of antennas at the transmitting site and N_{R} represents the number of antennas at the receiving site, where N_{T} and N_{R} are each greater than 1. FIG. 3 depicts a block-diagram of a MIMO system 300 wherein both a receiving site and a transmitting site have space diversity. Generally speaking, MIMO system 300 provides multi-antenna signal processing in both the transmitting and receiving sites. These functionalities are represented in FIG. 3 by joint encoding-mapping-modulation block 310 and a multi-antenna signal processing block 320, respectively.

At the transmitting site, the data to be transmitted can be combined by joint encoding-mapping-modulation block 310 in a plurality of different manners before transmission. In one example, data symbols are transmitted in parallel. That is, the same data is transmitted through all antennas. In this case, the multiple antennas at the transmitting site are only used as a source of spatial diversity and not to increase data rate, at least not in a direct manner. In another example, different data symbols are transmitted through different antennas (time-space diversity). For instance, data symbols can be combined in groups for transmission through different antennas. As another example, encoded data symbols can be transmitted separately from redundant symbols using different antennas. In addition, other combination schemes can be used at the transmitting site as would be apparent to a person skilled in the relevant art(s).

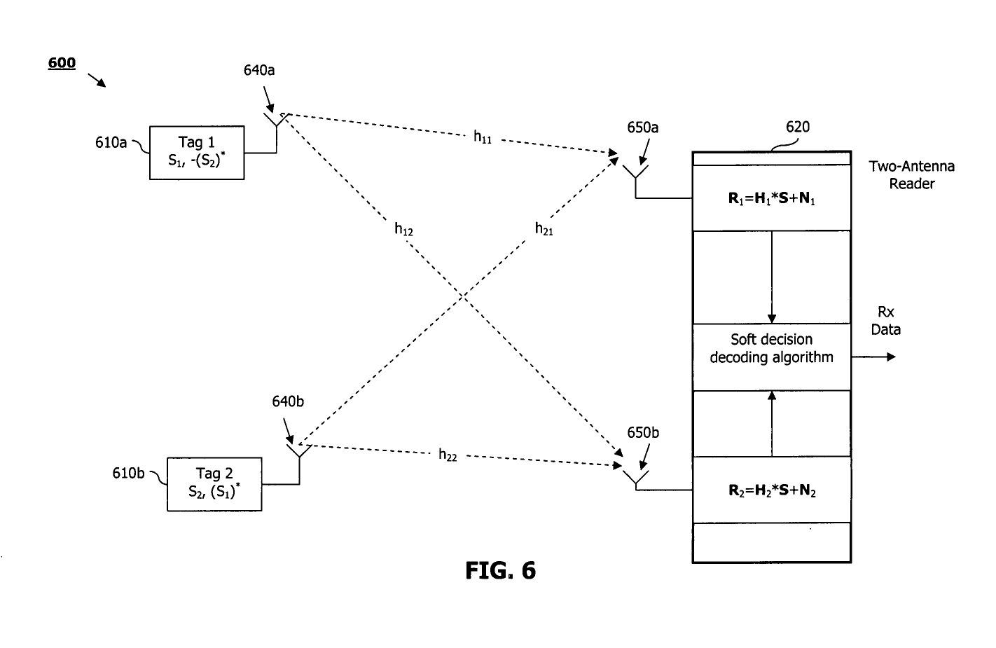

A particular type of combination scheme used in MIMO systems is called a Space-Time Block Code (STBC). A STBC exploits the redundancy in the multiple copies of the transmitted data to increase the data rate of a MIMO system. Another type of combination scheme used in MIMO systems is a Space-Time Trellis code (STTC). An STTC also exploits the redundancy in the multiple copies of the transmitted data, but the encoding and decoding is generally more complex than a STBC. An efficient STBC can provide the same or similar energy gain as a Space-Time Trellis Code, but can be implemented based on simple linear operations. One of the simplest STBC, known as the Alamouti code, provides a simple and an efficient solution for a 2:2 MIMO system. An embodiment of the present invention implementing an Alamounti code is described below with reference to FIG. 6.

The receiving site of MIMO system 300 has N_{R} spatially diverse receiving antennas with corresponding HF front ends. The MIMO receiver provides the same or similar multi-antenna signal processing as radio system 200 with space diversity. That is, signal processing block 320 includes an algorithm for linearly combining partial signals received by the spatially diverse antennas. The partial signals are linearly combined in order to provide the maximum likely estimation of the transmitted data. Optimal signal processing of the multi-antenna signal is based on weighted coherent or non-coherent accumulation of spaced antenna signals. Signal processing at the receiving site can also include some specific linear or non-linear procedures depending on the data-combining manner in the transmitter. For example, a Viterbi soft-decision decoding procedure can be used for trellis codes or an iterative decoding procedure can be used for low-density parity-check (LDPC) codes.

In MIMO system 300, the number of signal replicas received at the receiving site is equal to a product of the number of spatially diverse antennas at the respective sites, i.e., N_{T}×N_{R}. Therefore, in MIMO system 300, increasing the number of antennas at both the receiving site and the transmitting site results in a linear increase in channel capacity (Shannon factor), rather than the logarithmic increase as is the case for conventional radio system 200 with space diversity. For example, a MIMO system having four transmitting antennas and four receiving antennas has a channel capacity four times greater than a single antenna system, and two times greater than a radio system with four spatially diverse antennas at the receiving site. Mathematically, this can be represented as
C_{(N}_{_{T}}_{:N}_{_{R}}₎˜log₂(N_{T}×N_{R})C_{(1:1)}˜log₂(4×4)C_{(1:1)}˜4C_{(1:1)} (2)
where C_{(N}_{_{T}}_{:N}_{_{R}}₎ is the channel capacity of a MIMO system with N_{T} transmitting antenna (which in this example is four) and N_{R} receiving antennas (which in this example is four), and C_{(1:1)} is the channel capacity of a Single Antenna system. Recall from equation (1) that C_{(1:4)}=2C_{(1:1)}, which combined with equation (2) shows that C_{(4:4)}=2C_{(1:4)}=4C_{(1:1)}.

Although a MIMO system can achieve increased channel capacity, this increase is achieved with the creation of certain complications of the radio system, especially at the receiving site. For example, according to estimations, a 4:4 MIMO receiver is approximately two times more complex than a conventional 1:1 receiver.

Example Architectures

As mentioned above and described below, an embodiment of the present invention provides a system that integrates the RFID and MIMO technologies. In an embodiment, an integrated RFID/MIMO system includes (1) a plurality of RFID tags and (2) a reader having a plurality of antennas. In another embodiment, an integrated RFID/MIMO system includes (1) a plurality of RFID tags and (2) a plurality of readers each having an antenna. In further embodiments, readers with single antennas and readers with multiple antennas are combined in implementations.

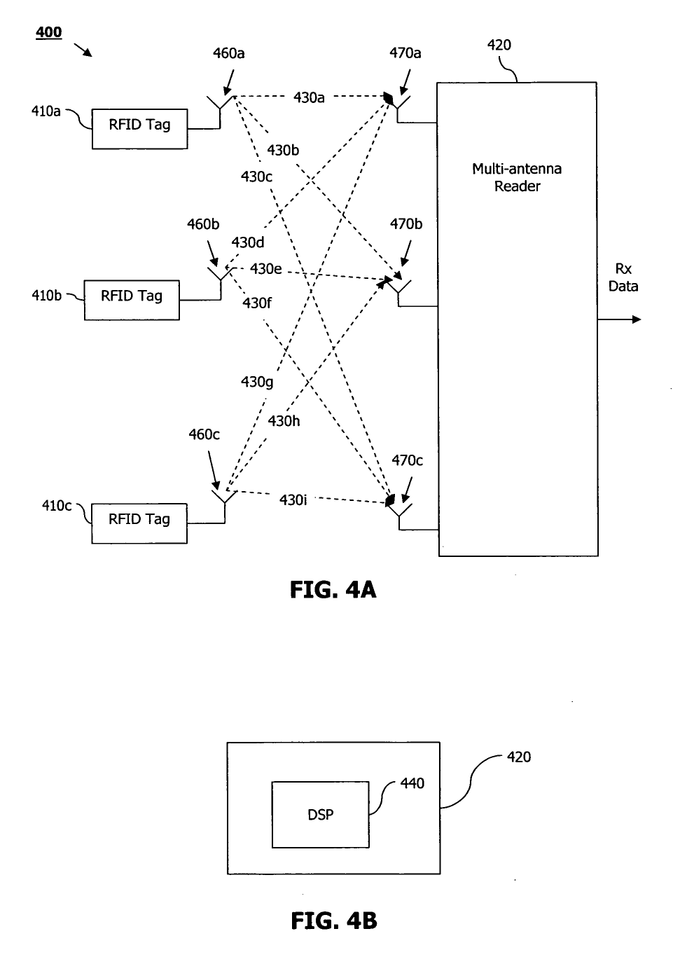

FIG. 4A illustrates a first integrated RFID/MIMO system 400 in accordance with an embodiment of the present invention. RFID/MIMO system 400 includes a single reader 420 having a plurality of spatially diverse antennas 470 and a plurality of RFID tags 410. As shown in FIG. 4A, RFID/MIMO system 400 includes a first RFID tag 410a having a first antenna 460a, a second RFID tag 410b having a second antenna 460b, and a third RFID tag 410c having a third antenna 460c, and reader 420 includes a first antenna 470a, a second antenna 470b and a third antenna 470c. It is to be appreciated, however, that RFID/MIMO system 400 is shown for illustrative purposes only, and not limitation. For example, it is to be appreciated that the number of RFID tags 410 included in RFID/MIMO system 400, and/or the number of antennas included on reader 420, can be increased or decreased without deviating from the spirit and scope of the present invention.

The plurality of RFID tags 410 provide a multiple antenna configuration at the transmitting side of RFID/MIMO system 400. In the case of passive tags, RFID tag 410a, RFID tag 410b and RFID tag 410c each modulates and backscatter transmits a signal 430 received from reader 420. The plurality of antennas 470 on reader 420 provide a multiple antenna configuration at the receiving side of RFID/MIMO system 400. As described below, antennas 470 are spatially diverse. Each spatially diverse antenna 470 of reader 420 can include a corresponding HF front end, as would be apparent to a person skilled in the relevant art(s). FIG. 4B shows reader 420 including a processing module 440. Processing module 440 can be any type of signal processor that provides baseband multi-antenna signal processing, such as a microprocessor, an analog signal processor, a digital signal processor (DSP), a field programmable gate array (FPGA), or another signal processor as would be apparent to a person skilled in the relevant art(s).

As shown in FIG. 4A, antennas 460 backscatter transmit signals that are received by antennas 470 of reader 420. For example, antenna 470a receives the signal transmitted by antenna 460a along path 430a, antenna 470b receives the signal transmitted by antenna 460a along path 430b, and antenna 470c receives the signal transmitted by antenna 460a along path 430c. Similarly, antenna 470a receives the signal transmitted by antenna 460b along path 430d, antenna 470b receives the signal transmitted by antenna 460b along path 430e, and antenna 470c receives the signal transmitted by antenna 460b along path 430f. Likewise, antenna 470a receives the signal transmitted by antenna 460c along path 430g, antenna 470b receives the signal transmitted by antenna 460c along path 430h, and antenna 470c receives the signal transmitted by antenna 460c along path 430i. By using a plurality of RFID tags 410 to backscatter transmit a signal along a corresponding plurality of paths 430, RFID/MIMO system 400 can achieve a greater operational range compared to a conventional RFID system.

In principle, multiple-antenna reader 420 could also transmit a continuous wave (CW) signal (not shown in FIG. 4A) through one antenna 470a or several of antennas 470. By transmitting CW, RFID/MIMO system 400 can be implemented as a two directional system.

Processing module 440 of reader 420 combines the received plurality of partial signals based on a likely estimation of the transmitted data to produce an output signal. To ensure proper signal diversity antennas 470 are spaced from each other, for example, by a fraction of a wavelength of a signal of interest, or by a multiple of a wavelength. For example, a minimum spacing of ½λ between antennas 470 can be used, where λ is the carrier wave length (for a 1 GHz carrier, ½λ=0.15 m). Processing module 440 can combine the partial signals in a variety of manners as would be apparent to a person skilled in the relevant art(s). For example, a Viterbi soft-decision decoding procedure can be used for trellis codes, an iterative decoding procedure can be used for low-density parity-check (LDPC) codes, or other decoding procedures can be used as would be apparent to a person skilled in the relevant art(s). Processing module 440 may be implemented in hardware, software, firmware, or any combination thereof.

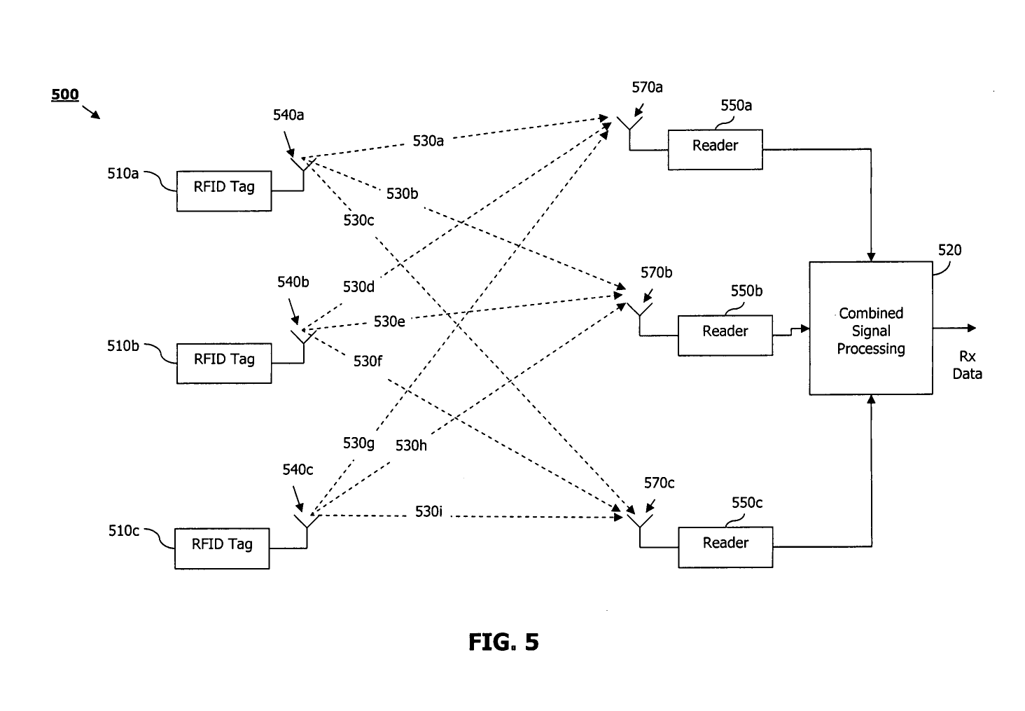

FIG. 5 illustrates a second RFID/MIMO system 500 in accordance with another embodiment of the present invention. RFID/MIMO system 500 includes a plurality of RFID tags 510 and a plurality of spatially diverse readers 550 (a multiple-reader environment). In particular, as shown in FIG. 5, RFID/MIMO system 500 includes a first RFID tag 510a including an antenna 540a, a second RFID tag 510b including an antenna 540b, a third RFID tag 510c including an antenna 540c, a first reader 550a including an antenna 570a, a second reader 550b including an antenna 570b, and a third reader 550c including an antenna 570c. It is to be appreciated, however, that RFID/MIMO system 500 is shown for illustrative purposes only, and not limitation. For example, it is to be appreciated that the number of RFID tags 510 and/or the number of readers 550 included in RFID/MIMO system 500 can be increased or decreased without deviating from the spirit and scope of the present invention.

The plurality of RFID tags 510 provide a multiple antenna configuration at the transmitting side of RFID/MIMO system 500, in a similar manner to RFID tags 410 of RFID/MIMO system 400. The plurality of antennas 570, corresponding to the plurality of readers 550, provide the multiple antenna configuration at the receiving side of RFID/MIMO system 500.

As shown in FIG. 5, antennas 540 backscatter transmit signals that are received by antennas 570 of readers 550. For example, antenna 570a of reader 550a receives the signal transmitted by antenna 540a along path 530a, antenna 570b of reader 550b receives the signal transmitted by antenna 540a along path 530b, and antenna 570c of reader 550c receives the signal transmitted by antenna 540a along path 530c. Similarly, antenna 570a of reader 550a receives the signal transmitted by antenna 540b along path 530d, antenna 570b of reader 550b receives the signal transmitted by antenna 540b along path 530e, and antenna 570c of reader 550c receives the signal transmitted by antenna 540b along path 530f. Likewise, antenna 570a of reader 550a receives the signal transmitted by antenna 540c along path 530g, antenna 570b of reader 550b receives the signal transmitted by antenna 540c along path 530h, and antenna 570c of reader 550c receives the signal transmitted by antenna 540c along path 530i.

As mentioned above with respect to RFID/MIMO system 400, by using a plurality of RFID tags 510 to backscatter transmit a signal along a corresponding plurality of paths 530, RFID/MIMO system 500 can achieve a greater operational range compared to a conventional RFID system. In addition, in RFID/MIMO system 500, one of readers 550 can serve as a CW signal source (not shown) for RFID tags 510, if desired.

Readers 550a-c are coupled to a combined signal processing module 520. Processing of the multiple signals received by readers 550 is provided by combined signal processing module 520, in a similar manner to processing module 440 of reader 420 of FIG. 4B. Combined signal processing module 520 may be coupled to readers 550 via a wired or wireless connection. Alternatively, combined signal processing module 520 may be a portion of one of the plurality of readers 550, for example, reader 550a. By utilizing plurality of readers 550, RFID/MIMO system 500 can achieve a relatively low signal power, while realizing a high data rate and operational range.

In a similar manner to processing module 440 of reader 420, combined signal processing module 520 can combine the partial signals in a variety of manners as would be apparent to a person skilled in the relevant art(s). For example, a Viterbi soft-decision decoding procedure can be used for trellis codes, an iterative decoding procedure can be used for low-density parity-check (LDPC) codes, or some other decoding procedure can be used as would be apparent to a person skilled in the relevant art(s).

Given the example architectures described with references to FIGS. 4A and 5, an integrated RFID/MIMO system can be operated in several ways, as described in the next section.

Example Operation

As mentioned above, a reader of an integrated RFID/MIMO system (such as, reader 420 of FIG. 4A or readers 550 of FIG. 5) may be approximately two times more complex than a reader in a conventional RFID system. On the other hand, an RFID tag of an integrated RFID/MIMO system (such as, RFID tags 410 of FIG. 4A or RFID tags 510 of FIG. 5) may or may not be more complicated than an RFID tag in a conventional RFID system.

In an embodiment, the plurality of RFID tags 410 of RFID/MIMO system 400, or the plurality of RFID tags 510 of RFID/MIMO system 500, are similar to conventional RFID tags. In this embodiment, the plurality of RFID tags at the transmitting side are only used as a source of spatial diversity due to their diverse locations, and combined signal processing is performed at the receiving side, either by multi-antenna reader 420, by combined signal processing block 520, or by some combination thereof.

In another embodiment, RFID tags 410 of RFID/MIMO system 400, and/or RFID tags 510 of RFID/MIMO system 500, are modified to provide for increased data rate and decoding reliability. For example, an RFID/MIMO system in accordance with an embodiment of the present invention can be based on a space-time block code (STBC), an Alamouti STBC, a STTC, or some other code that utilizes the redundancy in the multiple copies of the transmitted data as would be apparent to a person skilled in the relevant art(s). For illustrative purposes, and not limitation, an RFID/MIMO system based on an Alamouti STBC is described below.

FIG. 6 illustrates a 2:2 RFID/MIMO system 600 based on an Alamouti STBC in accordance with an embodiment of the present invention. RFID/MIMO system 600 includes a first tag 610a, a second tag 610b and a reader 620. Reader 620 includes two spatially diverse antennas, a first antenna 650a and a second antenna 650b. While RFID/MIMO system 600 is shown with reader 620 having two spatially diverse antennas, it is to be appreciated that a 2:2 RFID/MIMO system based on an Alamouti STBC could also be implemented with two spatially diverse readers each having an antenna. It is submitted that such an implementation will become apparent to a person skilled in the relevant art(s) upon reading the description contained herein. Furthermore, it is to be appreciated that a 2:2 RFID/MIMO system based on an Alamouti STBC is shown for illustrative purposes only, and not limitation. For example, it is to be appreciated that an N_{T}:N_{R} RFID/MIMO system based on proper STBC, where N_{T} and N_{R} are any positive integers greater than one, is also contemplated within the spirit and scope of the present invention.

According to an Alamouti STBC, a pair of complex signal waveforms S₁ and S₂, corresponding to two adjacent bits, are combined in the transmitting side of RFID/MIMO system 600. In terms of system 600 shown in FIG. 6, this means that RFID tag 610a sequentially transmits waveforms S₁ and −(S₂)*, where star * denotes complex conjugation. Corresponding to the times when RFID tag 610a transmits waveforms S₁ and −(S₂)*, tag 610b sequentially transmits waveforms S₂ and (S₁)*, respectively.

The partial signals received by antenna 650a and antenna 650b of reader 620 are now expressed mathematically. To do so, let hᵢⱼ be a complex transfer coefficient from transmitting antenna i to receiving antenna j, where the index i takes on values 1 and 2 corresponding to antenna 640a of RFID tag 610a and antenna 640b of RFID tag 610b, respectively, and index j takes on values 1 and 2 corresponding to antenna 650a and antenna 650b, respectively.

Then, a pair of partial signals R₁₁ and R₁₂ received by antenna 650a of reader 620 can be represented as follows:
R₁₁=h₁₁S₁+h₂₁S₂+N₁₁, (3a)
R₁₂=h₁₁(−S₂)*+h₂₁(S₁)*+N₁₂, (3b)
where N₁₁ and N₁₂ are noise waveforms in antenna 650a at time intervals corresponding to signals S₁ and S₂.

Equation (3) can be represented in matrix form as follows:

$${R}_{1} = {H}_{1} S + {N}_{1} , \\ where \begin{matrix}{R}_{1} = {[ {R}_{11} , {R}_{12} ]}^{T} , \\ S = {[ {S}_{1} , {{S}_{2}}_{,} ]}^{T} , \\ {N}_{1} = {[ {N}_{11} , {N}_{12} ]}^{T} ,\end{matrix} \\ and {H}_{1} = ( \begin{matrix}{h}_{11} & {h}_{21} \\ {( {h}_{21} )}^{*} & - {( {h}_{11} )}^{*}\end{matrix} ) . \qquad ( 4 )$$

Similarly, a pair of signals R₂₁ and R₂₂ received by antenna 650b of reader 620 can be represented as follows:
R₂=H₂S+N₂, (5)
where R₂=[R₂₁, R₂₂]^{T}, S=[S₁, S₂]^{T}, N₂=[N₂₁, N₂₂]^{T}, where N₂₁ and N₂₂ are noise waveforms in antenna 650b at time intervals corresponding to signals S₁ and S₂, and

$${H}_{2} = ( \begin{matrix}{h}_{12} & {h}_{22} \\ {( {h}_{22} )}^{*} & - {( {h}_{12} )}^{*}\end{matrix} ) .$$

A soft decision decoding algorithm based on equations (4) and (5) for each pair of transmitted waveforms can be used in reader 620, such as in processing module similar to processing module 440 of FIG. 4B. Such a soft decision decoding algorithm produces an output signal based on the most likely estimation of the pair of transmitted bits.

Example Method

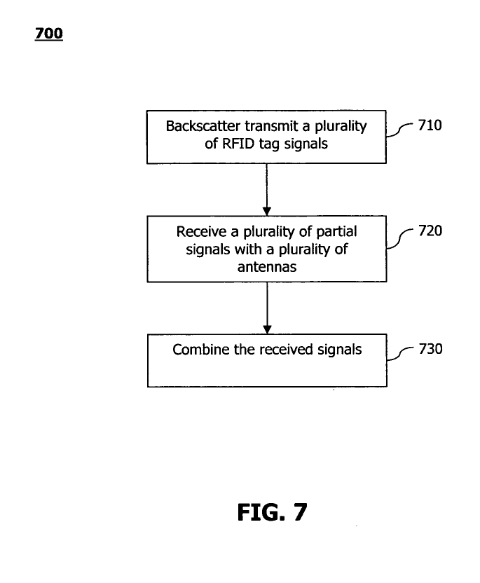

FIG. 7 depicts a flowchart 700 illustrating a method for transmitting and receiving signals in an integrated RFID/MIMO system in accordance with an embodiment of the present invention. For example, the method steps of flowchart 700 can be implemented in RFID/MIMO system 400, RFID/MIMO system 500, RFID/MIMO system 600, or a similar or equivalent RFID/MIMO system as would be apparent to a person skilled in the relevant art(s).

Flowchart 700 begins at a step 710 in which a plurality of RFID tag signals are backscatter transmitted. In an embodiment, the RFID tags are spatially diverse and the RFID tag signals are backscatter transmitted in parallel. In this embodiment, the signals are not combined in any way before backscatter transmission. In other words, the RFID tags used in this embodiment are similar to conventional RFID tags. In another embodiment, the RFID tag signals are combined before backscatter transmission to provide for increased data rate and decoding reliability. For example, in this embodiment the backscatter transmitted signals can be combined based on a STBC, an Alamouti STBC, a STTC, or some other combination scheme as would be apparent to a person skilled in the relevant art(s). In other words, the RFID tags used in this embodiment are specially modified RFID tags.

In a step 720, a plurality of partial signals corresponding to the transmitted plurality of RFID tag signals are received with a plurality of antennas, where each antenna in the plurality of antennas receives the plurality of partial signals. In an embodiment, the plurality of antennas are included on a single reader, such as reader 420. In another embodiment, each antenna in the plurality of antennas is included on a single reader, such as reader 550a, reader 550b or reader 550c of FIG. 5.

In a step 730, the received plurality of partial signals are combined to produce an output signal. For example, the partial signals could be combined by a module associated with multi-antenna reader 420, such as processing module 440, or by combined signal processing block 520 of FIG. 5. In an embodiment in which the backscatter transmitted signals are combined based on a STBC, an Alamouti STBC, a STTC, or some other combination scheme, the partial signals can be combined based on a soft decision algorithm, as would be apparent to a person skilled in the relevant art(s).

### CONCLUSION

While various embodiments of the present invention have been described above, it should be understood that they have been presented by way of example only, and not limitation. It will be apparent to a person skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A system, comprising:
a plurality of radio frequency identification (RFID) tags, wherein each RFID tag backscatter transmits a signal; and
a reader comprising a plurality of antennas and a signal processor, wherein each antenna of the plurality of antennas receives a plurality of signals corresponding to the backscatter transmitted signals, and wherein the signal processor combines the plurality of signals received by each antenna of the plurality of antennas to produce an output signal.

2. The system of claim 1, wherein the plurality of antennas are spatially diverse.

3. The system of claim 2, wherein a spacing between antennas of the plurality of antennas is approximately equal to one half a carrier wavelength of the backscatter transmitted signals.

4. The system of claim 1, wherein the reader is configured to transmit a continuous wave from at least one antenna of the plurality of antennas.

5. The system of claim 1, wherein the RFID tags are configured to backscatter transmit a signal based on one of a space-time block code (STBC) or a space-time trellis code (STTC).

6. The system of claim 5, wherein the signal processor combines the received plurality of signals based on a soft decision decoding algorithm to produce an output signal.

7. The system of claim 1, wherein a pair of RFID tags is configured to backscatter transmit a signal based on an Alamounti space-time block code (STBC).

8. The system of claim 7, wherein the signal processor combines the received plurality of signals based on the Alamounti STBC to produce an output signal.

9. A system, comprising:
a plurality of radio frequency identification (RFID) tags, wherein each RFID tag backscatter transmits a signal;
a plurality of readers each comprising an antenna, wherein each antenna receives a plurality of signals corresponding to the backscatter transmitted signals; and
a signal processor that combines the plurality of signals received by each antenna to produce an output signal.

10. The system of claim 9, wherein the plurality of antennas are spatially diverse.

11. The system of claim 10, wherein a spacing between antennas of the plurality of antennas is approximately equal to one half a carrier wavelength of the backscatter transmitted signals.

12. The system of claim 9, wherein at least one reader of the plurality of readers is configured to transmit a continuous wave.

13. The system of claim 9, wherein the RFID tags are configured to backscatter transmit a signal based on one of a space-time block code (STBC) or a space-time trellis code (STTC).

14. The system of claim 13, wherein the signal processor combines the received plurality of signals based on a soft decision decoding algorithm to produce an output signal.

15. The system of claim 9, wherein a pair of RFID tags is configured to backscatter transmit a signal based on an Alamouti space-time block code (STBC).

16. The system of claim 15, wherein the signal processor combines the received plurality of signals based on the Alamouti STBC to produce an output signal.

17. A method, comprising:
backscatter transmitting a plurality of radio frequency identification (RFID) tag signals;
receiving with each antenna of a plurality of antennas a plurality of signals corresponding to the backscatter transmitted plurality of RFID signals; and
combining the plurality of signals received by each antenna to produce an output signal.

18. The method of claim 17, wherein the receiving step comprises:
receiving with each antenna of a plurality of spatially diverse antennas the plurality of signals corresponding to the backscatter transmitted plurality of RFID signals.

19. The method of claim 18, wherein a spacing between antennas of the spatially diverse antennas is approximately equal to one half a carrier wavelength of the backscatter transmitted signals.

20. The method of claim 17, further comprising:
transmitting a continuous wave from at least one antenna of the plurality of antennas.

21. The method of claim 17, wherein the backscatter transmitting step comprises:
backscatter transmitting a plurality of RFID tag signals based on one of a space-time block code (STBC) or a space-time trellis code (STTC).

22. The method of claim 21, wherein the combining step comprises:
combining the received plurality of signals based on a soft decision decoding algorithm to produce an output signal.

23. The method of claim 17, wherein the backscatter transmitting step comprises:
backscatter transmitting a plurality of RFID tag signals based on an Alamouti space-time block code (STBC).

24. The method of claim 23, wherein the combining step comprises:
combining the received plurality of signals based on the Alamouti STBC to produce an output signal.
